(19) United States
(12) Patent Application Publication
(10) Pub. No.: US 2016/0207792 A1
(43) Pub. Date: Jul. 21, 2016

(54) METHODS AND APPARATUS FOR TREATING LIQUID CONTAINING SOLIDS

(71) Applicant: 643096 ALBERTA LIMITED, West Vancouver (CA)

(72) Inventor: David BROMLEY, West Vancouver (CA)

(73) Assignee: 643096 ALBERTA LIMITED, West Vancouver, BC (CA)

(21) Appl. No.: 14/917,240

(22) PCT Filed: Sep. 9, 2014
(86) PCT No.: PCT/CA2014/050856

§ 371 Date: Mar. 7, 2016

Related U.S. Application Data
(60) Provisional application No. 61/875,631, filed on Sep. 9, 2013.

(51) Int. Cl. C02F 1/24; B01D 21/01; C02F 1/52

(52) U.S. Cl. CPC C02F 1/24; C02F 1/52; B01D 21/01; C02F 2305/04; C02F 2301/024

(57) ABSTRACT

Methods and apparatus are provided for treating liquids containing solids. Liquid is introduced into the bore of a conduit having an injection site. The liquid has a flow direction in the bore and fills the bore at locations upstream of the injection site. Froth is injected into the liquid at the injection site. The injected froth disrupts the flow of the liquid and creates a froth-liquid mixture downstream from the injection site. The froth-liquid mixture exhibits turbulent flow in the flow direction and corresponding high-intensity mixing of the froth-liquid mixture. Solids may attach to surfaces of bubbles. The attachment of the solids may be promoted by the turbulent flow of the froth-liquid mixture and the corresponding high-intensity mixing. The froth may comprise a charged material that creates a charged environment which further promotes the attachment.

### TECHNICAL FIELD

The technology disclosed herein relates to the methods and apparatus for treating liquid containing solids. By way of non-limiting example, such solids may comprise suspended solids, colloidal solids and/or precipitated solids.

### BACKGROUND

Treatment of liquids, such as waste water, industrial water, and the like, may require the removal of solids suspended within the liquid. Such suspended solids may include colloidal solids.

One approach of removing solids suspended within a liquid involves the destabilization of the suspended solids.

Destabilization is typically effected through the use of coagulants. The coagulants neutralize the surface charge of suspended solids such that the suspended solids tend to clump together with one another in the process of flocculation. In this process, upon neutralization of the surface charge, the suspended solids aggregate as a floc and separate from the water (e.g. by flotation or by settlement).

There is an on-going desire for improved methods and apparatus for treating liquid (e.g. water) containing solids.

### BRIEF SUMMARY OF THE DISCLOSURE

The following embodiments and aspects thereof are described and illustrated in conjunction with systems, tools, and methods which are meant to be exemplary and illustrate, not limiting in scope. In various embodiments, one or more of the above-described problems have been reduced or eliminated, while some embodiments are directed to other improvements.

One aspect of the invention provides a method for treating a liquid containing solids. The method comprises: introducing the liquid into a conduit having a bore-defining surface which defines a bore, and an injection site for fluid injection into the bore, the liquid having a directional flow in a flow direction in the bore and the liquid filling the bore at locations upstream of the injection site; and injecting a froth into the liquid at the injection site, injecting the froth comprising: disrupting the directional flow of the liquid; and creating a froth-liquid mixture at locations downstream from the injection site, the froth-liquid mixture exhibiting turbulent flow in the flow direction and corresponding high-intensity mixing of the froth-liquid mixture.

In some embodiments, the method comprises attaching the solids to surfaces at interfaces between the bubbles and the liquid, the attachment of the solids promoted by the disruption of the directional flow of the liquid, the turbulent flow of the froth-liquid mixture and the corresponding high-intensity mixing. In some embodiments, injecting the froth comprises injecting the froth to move through the liquid and to impact the bore-defining surface at a location spaced apart and generally across the bore from the injection site. In some embodiments, disrupting the directional flow comprises causing some portions of the liquid to have velocity vectors with components oriented in a direction opposed to the flow direction. In some embodiments, disrupting the directional flow comprises causing some portions of the froth to have velocity vectors with components oriented in the direction opposed to the flow direction. In some embodiments, causing some portions of the froth to have velocity vectors with components oriented in the direction opposed to the flow direction comprises injecting the portions of the froth in directions having components oriented in the direction opposed to the flow direction. In some embodiments, causing some portions of the froth to have velocity vectors with components oriented in the direction opposed to the flow direction comprises injecting the froth to move through the liquid and to impact the bore-defining surface at a location spaced apart and generally across the bore from the injection site, the impact of the froth on the bore-defining surface at the location redirecting portions of the froth to have velocity vectors with components oriented in the direction opposed to the flow direction.

In some embodiments, the froth comprises a charged material and the method comprises creating a charged environment in the liquid to promote the attachment of the solids to surfaces at interfaces between the bubbles and the liquid. In some embodiments, the charged material comprises a surfactant. In some embodiments, the solids are surrounded by a double electric layer and the method comprises disrupting the double electric layer by the charged environment and by the high-intensity mixing of the froth-liquid mixture. In some embodiments, disrupting the double electric layer causes Van der Waals forces to promote the attachment of solids to surfaces at interfaces between the bubbles and the liquid. In some embodiment, the froth comprises surfactant (e.g. a liquid surfactant), a base liquid (e.g. water), and gas.

In some embodiments, the method comprises injecting a coagulant into at least one of the liquid and the froth-liquid mixture to promote the precipitation or polymerization of dissolved solids into precipitated solids and attaching the precipitated solids to the surfaces at the interfaces between the bubbles and the liquid, the attachment of the precipitated solids promoted by the disruption of the directional flow of the liquid and the high-intensity mixing of the froth-liquid mixture. In some embodiments, the dissolved solids comprise one or more of: silica, barium, strontium, calcium, magnesium, and compounds containing any of these elements.

In some embodiments, the method comprises mixing the froth-liquid mixture in a mixer to cause further turbulence in, and higher-intensity mixing of, the liquid-froth mixture and to further promote the attachment of the solids. In some embodiments, the conduit comprises a plurality of injection sites and the method comprises injecting the froth into the bore at the plurality of injection sites. In some embodiments, the injection sites are spaced apart at a distance that is less than or equal to five times a diameter of the bore.

In some embodiments, the method comprises introducing the froth-liquid mixture into a second conduit having a second bore-defining surface which defines a second bore; and injecting additional froth into the froth-liquid mixture in the second bore at one or more second conduit injection sites. In some embodiments, injecting the froth comprises selecting a pressure for froth injection wherein selecting the pressure is based at least in part on an average velocity of the directional flow of the liquid. In some embodiments, the turbulent flow of the froth-liquid mixture has a velocity gradient in the bore greater than 10 s⁻¹.

In some embodiments, the solids comprise one or more of: colloidal solids and suspended solids. In some embodiments, the liquid comprises one or more of: oil, water, waste water and industrial water. In some embodiments, the mixer comprises a static mixer, a dynamic mixer or a vortex mixer.

In some embodiments, the method comprises removing the bubbles and the solids attached to the surfaces at interfaces between the bubbles and the liquid.

Another aspect of the invention provides an apparatus for treating a liquid containing solids. The apparatus comprises a conduit having a bore-defining surface which defines a bore and an injection site for fluid injection into the bore, the liquid having a directional flow in a flow direction in the bore and filling the bore at locations upstream of the injection site; and a froth injected into the liquid at the injection site, the injected froth disrupting the directional flow of the liquid and creating a froth-liquid mixture comprising gaseous bubbles in the liquid at locations downstream from the injection site, the froth liquid mixture exhibiting a turbulent flow in the flow direction and corresponding high-intensity mixing of the froth-liquid mixture.

In some embodiments, the wherein the solids attach to surfaces at interfaces between the bubbles and the liquid, the attachment of the solids promoted by the turbulence and the disruption of the directional flow of the liquid. In some embodiments, the injected froth is injected at a pressure and direction which causes the injected froth to move through the liquid and impact the bore-defining surface at a location spaced apart from and generally across the bore from the injection site. In some embodiments, the disruption of the directional flow comprises some portions of the liquid having velocity vectors with components oriented in a direction opposed to the flow direction. In some embodiments, disruption of the directional flow comprises some portions of the froth having velocity vectors with components oriented in the direction opposed to the flow direction.

In some embodiments, the apparatus comprises a fluid injector operatively connected at the injection site and oriented for injection of the froth in directions which have velocity vectors with components oriented in the direction opposed to the flow direction. In some embodiments, the fluid injector may be operatively connected at the injection site and configured for injection of froth with momentum which causes the froth to move through the liquid and to impact the bore-defining surface at a location spaced apart and generally across the bore from the injection site, the impact of the froth on the bore-defining surface at the location redirecting portions of the froth to have velocity vectors with components oriented in the direction opposed to the flow direction of the liquid and/or mixture.

In some embodiments, the froth in the apparatus comprises a charged material for creating a charged environment in the liquid to promote the attachment of the solids. In some embodiments, the charged material comprises a surfactant. In some embodiments, the solids are surrounded by a double electric layer which is disrupted by the charged environment and the high-intensity mixing of the mixture. In some embodiments, the disruption of the double electric layer causes Van der Waals forces to promote the attachment of the solids to the interfaces at surfaces between the bubbles and the liquid in the mixture. In some embodiments, the froth comprises surfactant (e.g. a liquid surfactant), a base liquid (e.g. water), and gas.

In some embodiments, the apparatus comprises a coagulant injected into at least one of the liquid and the froth-liquid mixture, the coagulant promoting the precipitation or polymerization of dissolved solids into precipitated solids, the precipitated solids attaching to the surfaces of the interfaces between the bubbles and the liquid, and the attachment of the precipitated solids promoted by the disruption of the directional flow of the liquid and the high-intensity mixing of the froth-liquid mixture. In some embodiments, the dissolved solids comprise one or more of: silica, barium, strontium, calcium, magnesium, and compounds containing any of these elements.

In some embodiments, the apparatus comprises a mixer located downstream of the injection site for mixing the froth-liquid mixture to cause further turbulence in, and higher-intensity mixing of, the froth-liquid mixture and to further promote the attachment of the solids. In some embodiments, the mixer comprises a static mixer, a dynamic mixer or a vortex mixer.

In some embodiments, the conduit a plurality of injection sites for injection of the froth. In some embodiments, the injection sites are spaced apart at a distance that is at or less than five times the diameter of the bore.

In some embodiments, the apparatus comprises a second conduit having a second bore-defining surface defining a second bore, the second conduit connected to receive the froth-liquid mixture and comprising one or more second injection sites for injection of additional froth into the froth-liquid mixture in the second bore. In some embodiments, the second conduit is connected to receive the froth-liquid mixture from a mixer operatively connected between the conduit and the second conduit, the mixer mixing the froth-liquid mixture to cause further turbulence in, and higher-intensity mixing of, the froth-liquid mixture and to further promote the attachment of the solids to surfaces at interfaces between the bubbles and the liquid in the mixture.

In some embodiment, the apparatus comprises an injector operatively connected at the injection site for injecting the froth at an injection pressure, and the injection pressure based on a velocity of the directional flow of the liquid.

In some embodiments, the turbulent flow of the froth-liquid mixture has a velocity gradient in the bore greater than 10 s⁻¹.

In some embodiments, the solids comprise one or more of colloidal solids and suspended solids. In some embodiments, the liquid comprises one or more of: oil, water, waste water and industrial water.

In some embodiments, the apparatus comprises a separator for removing the bubbles and the solids attached to the surfaces at interfaces between the bubbles and the liquid.

In addition to the exemplary aspects and embodiments described above, further aspects and embodiments will become apparent by reference to the drawings and by study of the following detailed description.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a schematic diagram illustrating an apparatus for treating liquid containing solids according to an example embodiment.

FIG. 2A is a cross-sectional front view illustrating a flow of liquid containing solids within the bore of a conduit of an apparatus for treating such liquid according to an example embodiment.

FIG. 2B is a cross-sectional front view illustrating injection of froth into the FIG. 2A flow.

FIG. 2C is a cross-sectional side view illustrating a flow of liquid containing solids within the bore of a conduit of an apparatus for treating such liquid according to an example embodiment.

FIG. 2D is a cross-sectional side view illustrating disruption of the FIG. 2C flow.

FIG. 2E is an enlarged cross-sectional side view illustrating disruption of the FIG. 2C flow.

FIG. 3A is a schematic cross-sectional side view illustrating solids suspended in liquid within the bore of a conduit of an apparatus for treating such liquid according to an example embodiment.

FIG. 3B is a schematic cross-sectional side view illustrating injection of froth into the flow of the liquid containing solids within the bore of the FIG. 3A conduit.

FIG. 3C is a schematic cross-sectional side view illustrating attachment of solids to the surface of interfaces between the froth (e.g. bubbles) and the liquid within the bore of the FIG. 3A conduit.

FIG. 4 is a schematic cross-sectional side view illustrating an apparatus for treating liquid containing solids according to an example embodiment.

FIG. 5 is a schematic cross-sectional side view illustrating an apparatus for treating liquid containing solids according to an example embodiment.

### DESCRIPTION

Throughout the following description specific details are set forth in order to provide a more thorough understanding to persons skilled in the art. However, well known elements may not have been shown or described in detail to avoid unnecessarily obscuring the disclosure. The following description of examples of the technology is not intended to be exhaustive or to limit the system to the precise forms of any example embodiment. Accordingly, the description and drawings are to be regarded in an illustrative, rather than a restrictive, sense.

One aspect of the invention provides a method for treating a liquid containing solids. The method comprises: introducing the liquid into a conduit having a bore-defining surface which defines a bore, and an injection site for fluid injection into the bore, the liquid having a directional flow in a flow direction in the bore and the liquid filling the bore at locations upstream of the injection site; and injecting a froth into the liquid at the injection site, injecting the froth comprising: disrupting the directional flow of the liquid; and creating a froth-liquid mixture at locations downstream from the injection site, the froth-liquid mixture exhibiting turbulent flow in the flow direction and corresponding high-intensity mixing of the froth-liquid mixture. Another aspect of the invention provides an apparatus for treating a liquid containing solids. The apparatus comprises a conduit having a bore-defining surface which defines a bore and an injection site for fluid injection into the bore, the liquid having a directional flow in a flow direction in the bore and filling the bore at locations upstream of the injection site; and a froth injected into the liquid at the injection site, the injected froth disrupting the directional flow of the liquid and creating a froth-liquid mixture comprising gaseous bubbles in the liquid at locations downstream from the injection site, the froth liquid mixture exhibiting a turbulent flow in the flow direction and corresponding high-intensity mixing of the froth-liquid mixture.

In some embodiments, the solids are attached to surfaces at interfaces between the bubbles and the liquid. The attachment of the solids is promoted by the disruption of the directional flow of the liquid, the turbulent flow of the froth-liquid mixture and the corresponding high-intensity mixing. In some embodiments, the froth is injected with a momentum which causes the froth to move through the liquid and to impact the bore-defining surface at a location spaced apart and generally across the bore from the injection site. In some embodiments, the froth comprises charged surfactant and the solids are surrounded by a double electric layer which is disrupted by the charged environment caused by the charged surfactant in the froth and/or the high-intensity mixing of the froth liquid mixture. In some embodiments, disrupting the double electric layer causes Van der Waals forces to promote the attachment of the solids. In some embodiments, the froth comprises surfactant (e.g. liquid surfactant), a base liquid (e.g. water), and gas. In some embodiments, a coagulant is injected into the liquid to cause precipitation or polymerization of dissolved solids into precipitated solids and the attachment of the precipitated solids to the surfaces at the interfaces between the bubbles and the liquid. The attachment of the precipitated solids may be promoted by the disruption of the directional flow of the liquid and the high-intensity mixing of the froth-liquid mixture.

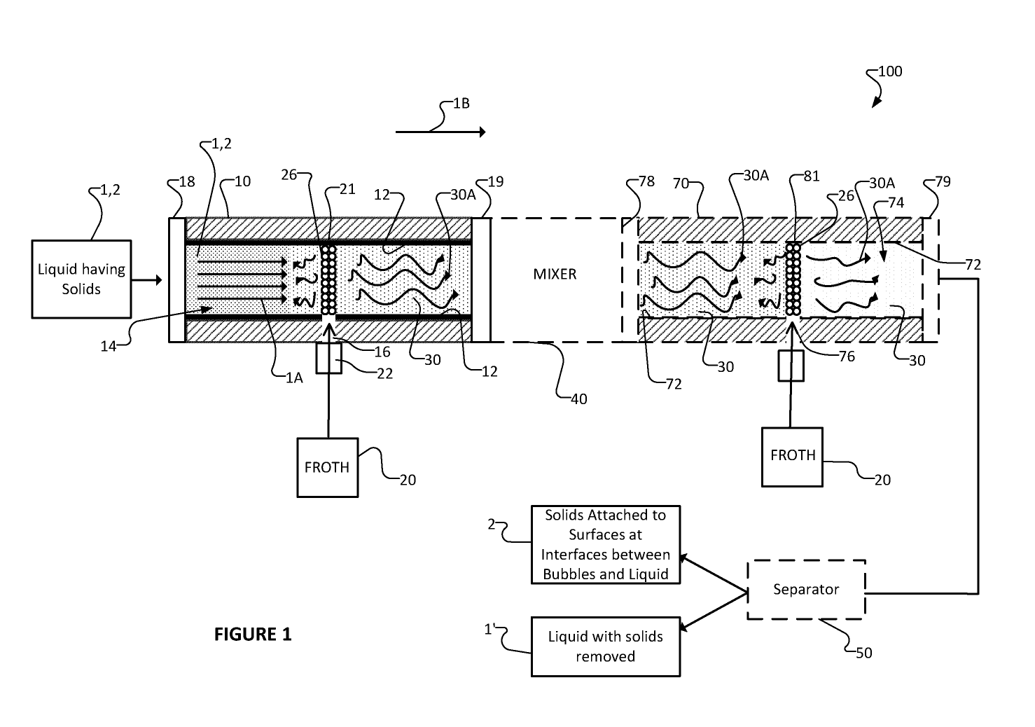

FIG. 1 is a schematic illustration of an apparatus 100 and a corresponding method for treating liquid containing solids according to an example embodiment. In the illustrated embodiment, apparatus 100 comprises conduit 10. Conduit 10 comprises a bore-defining surface 12 that defines a bore 14. Liquid 1 containing solids 2 (e.g. suspended solids and/or colloidal solids) may be introduced into conduit 10 through conduit inlet 18. Liquid 1 containing solids 2 has a directional flow 1A in bore 14 in a flow direction indicated by arrow 1B (i.e. in a direction from inlet 18 to outlet 19). Conduit 10 also comprises an injection site 16 where froth 20 is injected into bore 14 (e.g. by a suitably configured fluid injector 22 operatively coupled to conduit 10 at injection site 16). Liquid 1 fills bore 14 at locations upstream of injection site 16. Froth 20 injected into bore 14 at injection site 16 creates froth-liquid mixture at locations downstream of injection site 16. Froth-liquid mixture 30 comprises a mixture of liquid 1 containing solids and froth 20. Froth 20 comprises gas which creates gaseous bubbles 26 in mixture 30. The injection of froth 20 disrupts the directional flow 1A of liquid 1 and creates turbulent flow of froth-liquid mixture 30 in flow direction 1B downstream of injection site 16 and corresponding high-intensity mixing of mixture 30. The high-intensity mixing from turbulence and the disruption of directional flow 1A cause or promote solids 2 within liquid 1 to attach to surfaces 28 of bubbles 26 (e.g. surfaces 28 at interfaces between bubbles 26 and liquid 1). Froth-liquid mixture 30 fills bore 14 at locations downstream from injection site 16. Froth-liquid mixture 30 has a turbulent flow in flow direction 1B. The directional flow 1A of liquid 1 at locations sufficiently far upstream of injection site 16 so at not be significantly impacted by the injection of froth 20 may be laminar or turbulent. However, the turbulent flow of froth-liquid mixture 30 at locations downstream of injection site 16 is more turbulent than the directional flow 1A of liquid 1 at such upstream locations.

In some embodiments, conduit 10 comprises an outlet 19 and apparatus 10 comprises an optional mixer 40 in fluid communication with outlet 19. Outlet 19 may be operatively connected to optional mixer 40 directly or by pipes, hoses, conduits and/or or the like. In the FIG. 1 embodiment, optional mixer 40 comprises an inline mixer located between conduit 10 and an optional secondary conduit 70. In some embodiments, mixer 40 comprises a static mixer. In other embodiments, mixer 40 comprises a dynamic mixer. In some embodiments, mixer 40 comprises a vortex mixer. Froth-liquid mixture 30 may be introduced into mixer 40 through outlet 19, and mixer 40 mixes froth-liquid mixture 30 to cause further turbulence in, and higher intensity mixing of, mixture 30. This higher intensity mixing may corresponding to a velocity gradient that is 20% or more greater than the velocity gradient immediately preceding mixer 40. In some embodiments, this difference in velocity gradient may be greater than 25%. This further turbulence and higher intensity mixing further promotes the attachment of solids 2 within froth-mixture 30 to surfaces 28 of bubbles 26.

In some embodiments, apparatus 10 comprises an optional separator 50 in fluid communication with conduit 10 and/or with optional mixer 40 or optional secondary conduit 70. Conduit 10, optional mixer 40 and/or optional secondary conduit 70 may be operatively connected to separator 50 directly and/or by pipes, hoses, conduits and/or or the like. In one embodiment, separator 50 comprises a flotation tank. Separator 50 separates the solids 2 attached to interface surfaces 28 of bubbles 26 from mixture 30. In embodiments where separator comprises a flotation tank, the gaseous bubbles 26 (and attached solids 2) may float up to the top of the flotation tank (e.g. to a location at or near the top of the level of mixture 30 within the tank), where the solids 2 and froth 20 (including bubbles 26) may be removed. By way of non-limiting examples, solids 2 and froth 20 (including bubbles 26) may be removed from the top of mixture 30 by skimming and/or using hydraulic techniques (e.g. allowing an egress flow at or near the top of the level of mixture 30 in the tank). Liquid 1 may be returned into apparatus 100 for removal of any remaining solids 2. In some embodiments, separator 50 may comprise other suitable apparatus and/or techniques for removing froth 20 (including bubbles 26) and solids 2 from froth-liquid mixture 30.

In some embodiments, solids 2 comprise colloidal particles, suspended solids, precipitated solids and/or a combination of these types of solids. In some embodiments, liquid 1 containing solids 2 comprises waste water, industrial water, some combination of waste water and industrial water and/or the like. In some embodiments, liquid 1 containing solids 2 comprises oil, water and/or oil and water in combination. In general, liquid 1 containing solids 2 may comprise any suitable liquid.

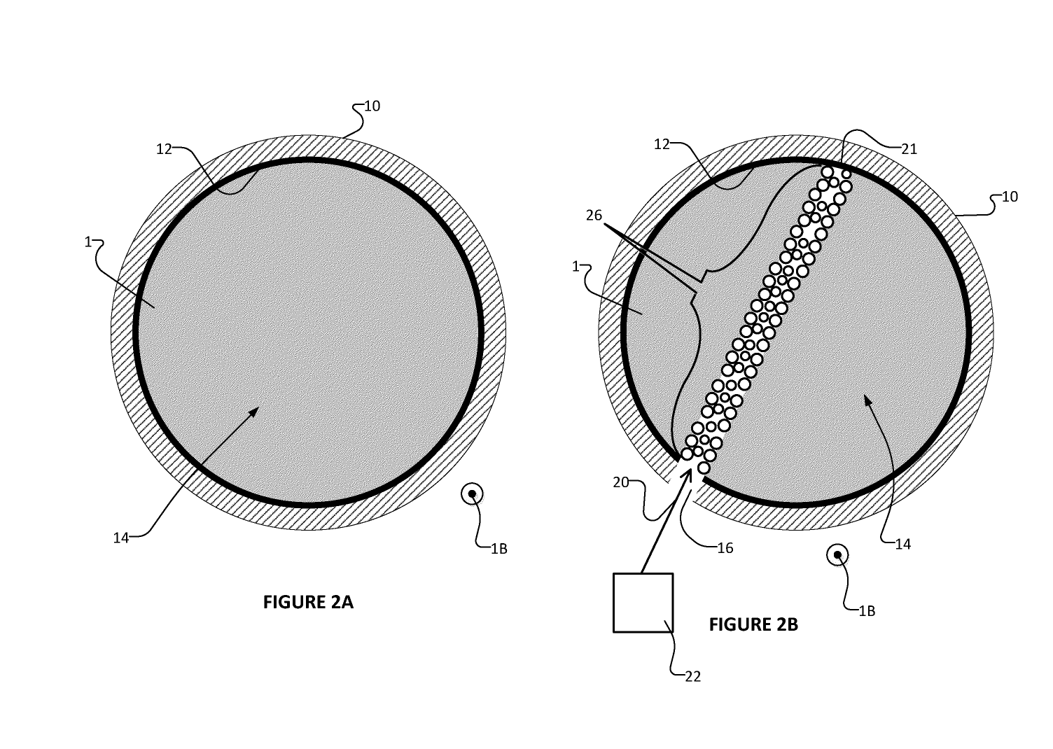

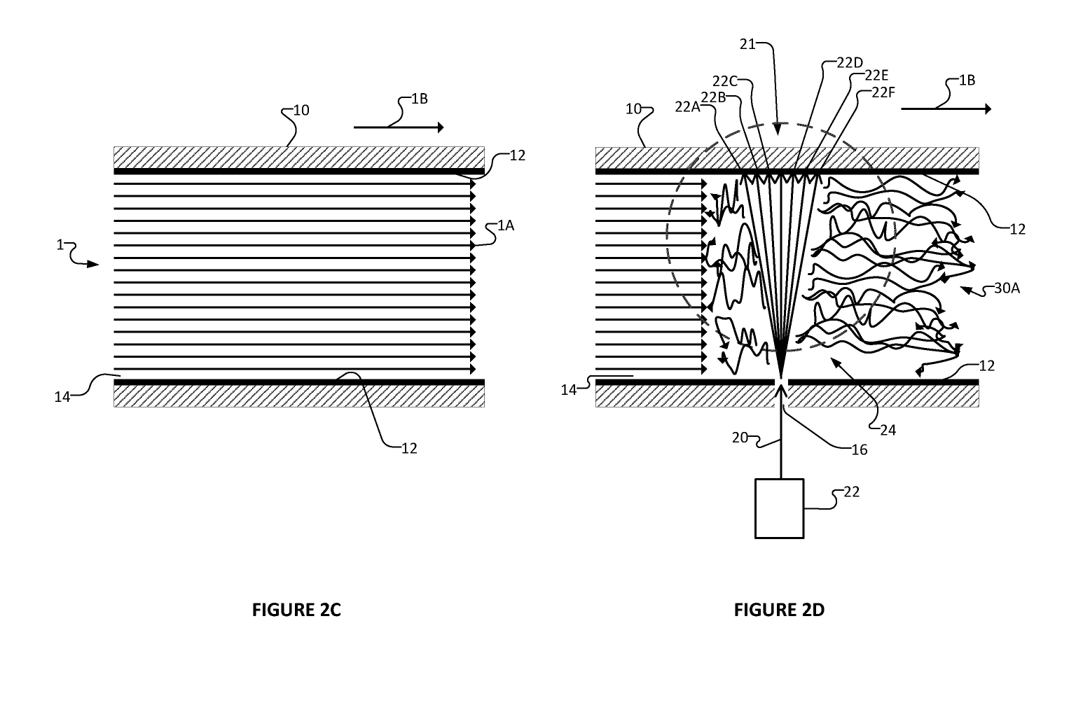

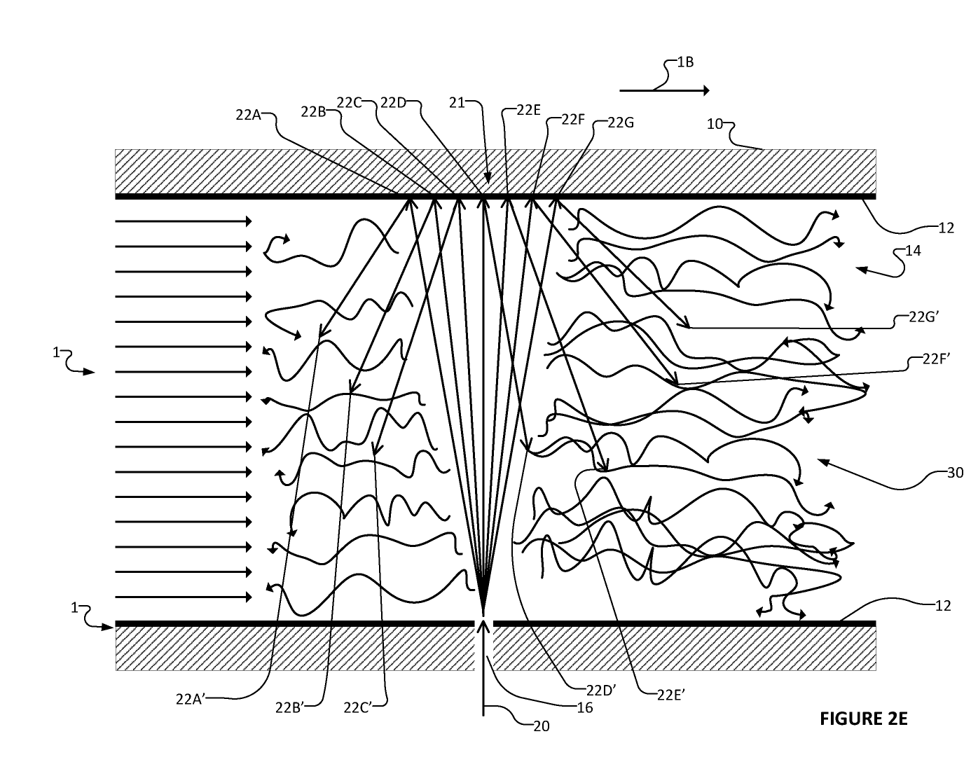

FIGS. 2A, 2B, 2C, 2D, and 2E schematically illustrate the injection of froth 20 into liquid 1 containing solids 2 within bore 14 of conduit 10. The general flow direction 1B is out of the page in the views of FIGS. 2A and 2B and is from left to right in the views of FIGS. 2C-2E. FIG. 2A shows a typical situation at locations sufficiently far upstream of injection site 16 so as to be not significantly impacted by the injection of froth 20. At such locations upstream of injection site 16, liquid 1 containing solids 2 fills the space within bore 14 and has a directional flow 1A within bore 14 in flow direction 1B. The directional flow 1A at these upstream locations is typically laminar, but is not limited to being laminar. While conduit 10 of the embodiment shown in FIGS. 2A and 2B comprises a pipe having an outer surface and a bore 14 with circular cross-sections, this is not necessary. In some embodiments, conduit 10, portions of conduit 10, bore 14 and/or portions of bore 14 may have other suitable cross-sectional shapes, including rectangular, triangular, and the like. Conduit 10 may also comprise curvature, corners and/or the like. In some embodiments, conduit 10 comprises a pipe made of steel, iron, metal alloy, aluminum, copper, plastic, concrete, clay, and/or the like.

As shown in FIG. 2B, froth 20 is injected into liquid 1 within bore 14 at injection site 16. Apparatus 100 may comprise a fluid injector 22 operatively coupled to injection site 16 for injecting froth 20 into liquid 1 in bore 14. Injection of froth 20 creates a froth-liquid mixture 30 in bore 14 at locations downstream of injection site 16. Froth-liquid mixture 30 comprises gaseous bubbles 26.

While bubbles 26 illustrated in FIG. 2B have generally similar sizes, gaseous bubbles 26 created by injection of froth 20 may have a variety of sizes. In some embodiments, injection site 16 and/or fluid injector 22 comprises a one-way valve (not expressly shown) to prevent leakage of liquid 1 or froth-liquid mixture 30 from bore 14. In some embodiments, injection site 16 may have an adapter fitted to receive froth from fluid injector 22 and/or from a pipe, vent, hose, combination thereof and/or the like. In some embodiments, froth 20 is pressurized with an injection pressure prior to injection into liquid 1 within bore 14. Such injection pressure may be generated by a configurable pump and/or the like (not shown). In some embodiments, fluid injector 22 may be operatively connected at the injection site 16 and oriented for injection of froth 20 (or portions thereof) in directions which have velocity vectors with components oriented in the direction opposed to flow direction 1B. In some embodiments, fluid injector 22 may be configured for injection of froth 20 (or portions thereof) with velocity speed and direction) and/or momentum (mass, speed and direction) which causes the froth 20 to move through the liquid 1 and to impact the bore-defining surface 12 at one or more locations spaced apart from, and generally across the bore 14 from, injection site 16. The impact of froth 20 on the bore-defining surface 12 at the one or more locations may redirect portions of froth 20 (e.g. portions of froth 20 may “rebound” or “bounce” off of bore defining surface 12). In some embodiments, portions of froth 20 redirected after impacting bore-defining surface 12 may have velocity vectors with components oriented in the direction opposed to flow direction 1B. In some embodiments, the injection pressure of froth 20 is determined and/or applied based on the pressure on liquid 1, which causes directional flow 1A of liquid 1 through bore 14. The injection pressure on froth 20 may be greater than the pressure on liquid 1. In some embodiments, the injection pressure may be greater than 2 times the pressure on liquid 1. In some embodiments, the injection pressure may be greater than 10 times the pressure on liquid 1. In some embodiments, the injection pressure of froth 20 may be determined and/or applied based on the composition of froth 20 and/or the cross-sectional area of conduit 10. In some embodiments, the injection pressure of froth 20 is 140 kpa or in the range between 70 kpa and 700 kpa. In some embodiments, the injection pressure of froth 20 is determined and/or applied based on a velocity of the directional flow 1A of liquid 1. In some embodiments, the injection pressure of froth 20 is positively correlated with the velocity of the directional flow of liquid 1. In some embodiment, fluid injector 22 is not required and froth 20 having any of the characteristics described herein may be injected into bore 14 using other suitable injection techniques—e.g. injection techniques comprising valve(s), pipe(s), vent(s), hose(s), combination thereof and/or the like

As illustrated in FIG. 2B, froth 20 may be injected into liquid 1 (e.g. with velocity and/or momentum) such that froth 20 moves through liquid 1 and impacts bore-defining surface 12 at one or more locations 21 spaced apart from the injection site 16. In the illustrated embodiment, location 21 is generally across the cross-section of bore 14 from the injection site 16. This is not necessary. Location 21 at which froth 20 impacts bore-defining surface 12 may be located anywhere away from the injection site 16. As discussed above, portions of froth that are redirected after impacting bore-defining surface 12 at location(s) 21 may be provided with velocity having components oriented in directions opposing flow direction 1B.

FIG. 2C illustrates the flow of liquid 1 within bore 14 at locations sufficiently far upstream of injection site 16 so as not to be significantly impacted by the injection of froth 20. At such upstream locations, liquid 1 has directional flow 1A in flow direction 1B which may be (but is not limited to) a laminar flow. As illustrated in FIGS. 2D and 2E, injection of froth 20 disrupts directional flow 1A and causes turbulent flow of mixture 30 at locations downstream of injection site 16 (relative to directional flow 1A at upstream locations) and corresponding high-intensity mixing of mixture 30. Mixture 30 may fill the entirety of bore 14 at locations downstream of injection site 16. Portions of froth 20, as shown in FIG. 2D, may have velocity vectors 22 (shown as 22A, 22B, 22C, 22D, 22E, 22F, and 22G), with components that are opposed or orthogonal to flow direction 1B. As more clearly shown in FIG. 2E, the impact of froth 20 against bore-defining surface 12 at location 21 causes redirection of some portion of froth 20. The redirected portions of froth 20 may have velocity vectors (shown as 22A′, 22B′, 22C′, 22D′, 22E′, and 22F′) that have components that are opposed or orthogonal to the average direction of directional flow 1A of liquid 1.

Upon injection of froth 20 into bore 14, froth-liquid mixture 30 is created, and mixture 30 has a turbulent flow relative to that of liquid 1 upstream of the injection site 16. Some portions of froth-liquid mixture 30 and/or liquid 1 within mixture 30 may have velocity vectors in directions that are opposed or orthogonal to the average direction of directional flow 1A. Froth-liquid mixture 30 also has an average directional flow 30A in flow direction 1B. Portions of froth 20 having velocity vectors with components opposed or orthogonal to the average direction of directional flow 30A may impart part of their momentum on mixture 30 and/or liquid 1 within mixture 30, causing some portions of mixture 30 and/or some portions of liquid 1 within mixture 30 to have velocity vectors with components opposed or orthogonal to flow direction 1B. The disruption of directional flow 1A, the creation of froth-liquid mixture 30, and portions of liquid 1, froth 20, and froth-liquid mixture 30 having velocity vectors with components opposed or orthogonal to flow direction 1B cause turbulence in froth-liquid mixture 30 which leads to high-intensity mixing of mixture 30. In some embodiments, mixture 30, after high-intensity mixing from turbulence, has a velocity gradient in the bore 14 that is greater than 10 s⁻¹. In some embodiments after injection of froth 20, froth-liquid mixture 30 has a velocity gradient in the bore 14 in the range between 10 s⁻¹ and 100 s⁻¹. The high-intensity mixing from turbulence 24 in froth-liquid mixture 30 and the disruption of directional flow 1A of liquid 1, caused by injection of froth 20, promote the attachment of solids 2 to surfaces 28 at interfaces between the bubbles 26 and liquid 1 within froth-liquid mixture 30 by increasing contact and collision between solids 2 and between solids 2 and surfaces 28. In some embodiments, as shown best in FIGS. 2D and 2E, froth-liquid mixture 30 and the turbulent flow and high-intensity mixing thereof may extend some distance upstream of injection site 16.

Froth 20 may generally comprise a mixture of gas and liquid. In some embodiments, froth 20 comprises a charged material (typically a liquid), and introduction of the charged material as part of froth 20 creates a charged environment in froth-liquid mixture 30 to promote the attachment of solids 2 to surfaces 28 at interfaces between the bubbles 26 and liquid 1 within froth-mixture 30. As used herein, a charged environment comprises an environment having localized charged regions which are positively or negatively charged and which may be formed from positive ions, negative ions, or a combination of positive and negative ions. In some embodiments, these localized regions have a positive charge or a negative charge. In some embodiments, the charged environment comprises a combination of localized positively charged regions and negatively charged regions. In some embodiments, the charged material comprises a surfactant. In some embodiments, the surfactant comprises an anionic surfactant, such as sulfate (including alkyl sulfates such as ammonium lauryl sulfate, sodium lauryl sulfate, sodium laureth sulfate (or sodium lauryl ether sulfate (SLES)), sodium myreth sulfate, alkyl-ether sulfates, and/or the like), sulfonate, phosphate, carboxylates, dioctyl sodium sulfosuccinate, perfluorooctanesulfonate (PFOS), perfluorobutanesulfonate, linear alkylbenzene sulfonates, and/or the like. In some embodiments, the surfactant comprises a cationic surfactant, such as monoalkyl ammonium chloride, dialkyl ammonium chloride, ethoxylated ammonium chloride, other quaternary salts, and/or the like. In some embodiments, the charged surfactant is a liquid.

The charged environment in mixture 30 and/or liquid 1, together with the high-intensity mixing from turbulence caused by introduction of froth 20, promote the attachment of solid 2 to surfaces 28 of bubbles 26 (e.g. the interface surfaces 28 between bubbles 26 and liquid 1) within mixture 30. Without wishing to be bound by theory, the inventor believes that the promotion of the attachment of solids 2 to surfaces at interfaces 28 between the bubbles 26 and liquid 1 within mixture 30 is an application of the so-called Derjaguin-Landau-Verwey-Overbeek (“DVLO”) phenomenon. According to the DVLO phenomenon, there are two forces causing attraction and repulsion of solids 2 in mixture 30. A so-called double-electric layer surrounding solids 2 causes repulsion of solids 2 from each other and/or from other constituents of mixture 30 and Van der Waal forces cause attraction. Where mixture 30 comprises a non-charged or low charged environment, the forces asserted by the double electric layers are stronger than the Van der Waals forces and cause repulsion of solids 2 from each other and/or from other constituents of mixture 30. Where mixture 30 comprises a sufficiently highly charged environment, the double electric layer around solids 2 is disrupted and Van der Waals forces allow solids 2 to attach to surfaces such as surfaces 28 at interfaces between bubbles 26 and liquid 1 in mixture 30.

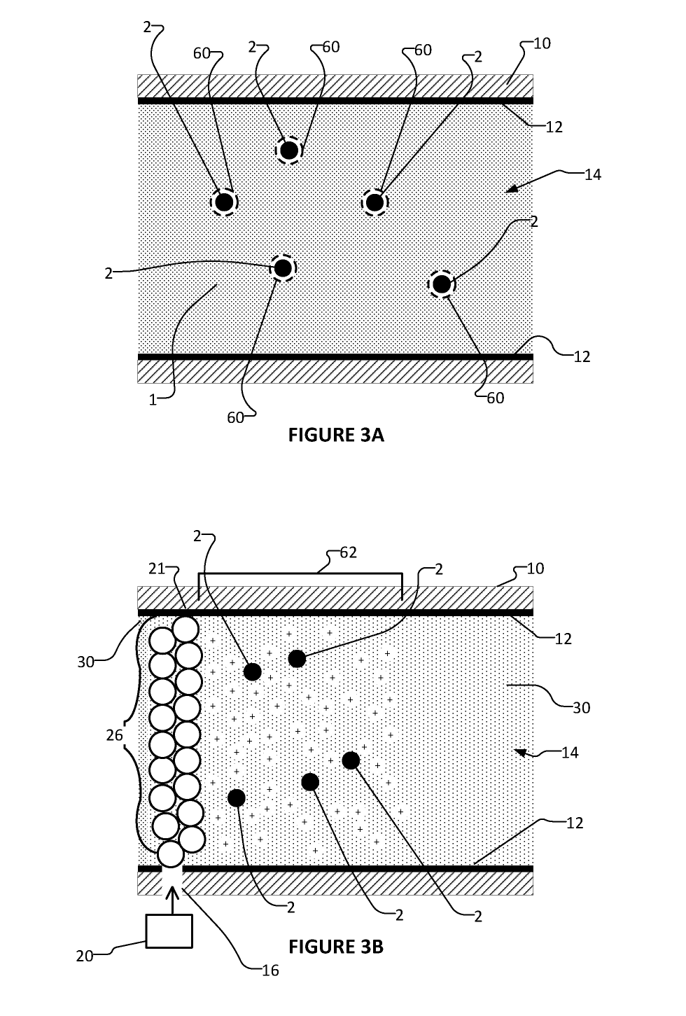

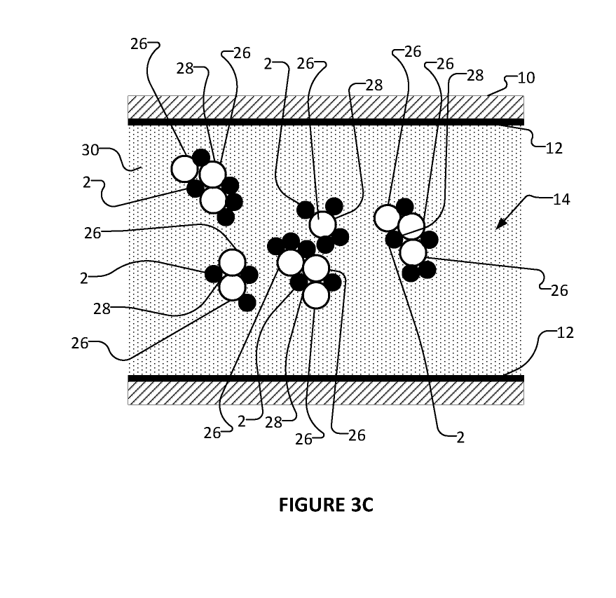

FIGS. 3A, 3B, and 3C illustrate the effect of the use of froth 20 comprising a charged material (e.g. a charged surfactant) and the creation of a charged environment in liquid 1. As shown in FIG. 3A, solids 2 in liquid 1 prior to injection of froth 20 are surrounded by a double electric layer 60. In the neutral (or relatively low-charge environment of liquid 1 prior to injection of froth 20), double-electric layers 60 cause solids 2 to stay dispersed within liquid 1 as they flow through bore 14 prior to the injection of froth 20.

Froth 20 comprising charged material is injected into liquid 1 at injection site 16. Similar to the injection shown in FIGS. 2B and 2D, in the embodiment illustrated by FIG. 3B, froth 20 creates gaseous bubbles 26 that travel through liquid 1. In the illustrated embodiments, injected gas bubbles 26 travel through liquid 1 within bore 14 and impact bore-defining surface at location 21 (which may be spaced apart from, and/or generally across bore 14 from, injection site 16) and may be redirected in various directions after impacting bore-defining surface 12. As shown in FIG. 3B, injection of froth 20 with charged material creates a charged environment 62 in mixture 30 and/or liquid 1. Injection of froth 20 also leads to high-intensity mixing of mixture 30 through turbulence and mixture 30 has a turbulent flow relative to that of liquid 1 upstream of the injection site 16. While charged environment 62 is shown as comprising positively charged local regions in FIG. 3B, charged environment 62 does not necessarily have to be positively charged. In some embodiments, charged environment 62 comprises negatively charged local regions. In some embodiments, charged environment 62 comprises positively charged regions and negatively charged regions.

As shown in FIG. 3B, charged environment 62 disrupts the double electric layer 60 surrounding solids 2. The high-intensity mixing of mixture 30 from turbulence and disruption of directional flow of liquid 1 may also help to disrupt double electric layer 60 surrounding solids 2. Disruption of double electric layer 60 does not require the complete collapse of double electric layer 60. In some embodiments, disruption of double electric layer 60 surrounding solids 2 may comprise the collapse, weakening, and/or compression of double electric layer 60. As illustrated in FIG. 3C, by disrupting the double electric layer 60, the charged environment 62, the high-intensity mixing of mixture 30 from turbulence, and/or the disruption of directional flow 1A of liquid 1 promote the attachment of solids 2 to surfaces 28 at the interfaces between liquid 1 and bubbles 26 in mixture 30.

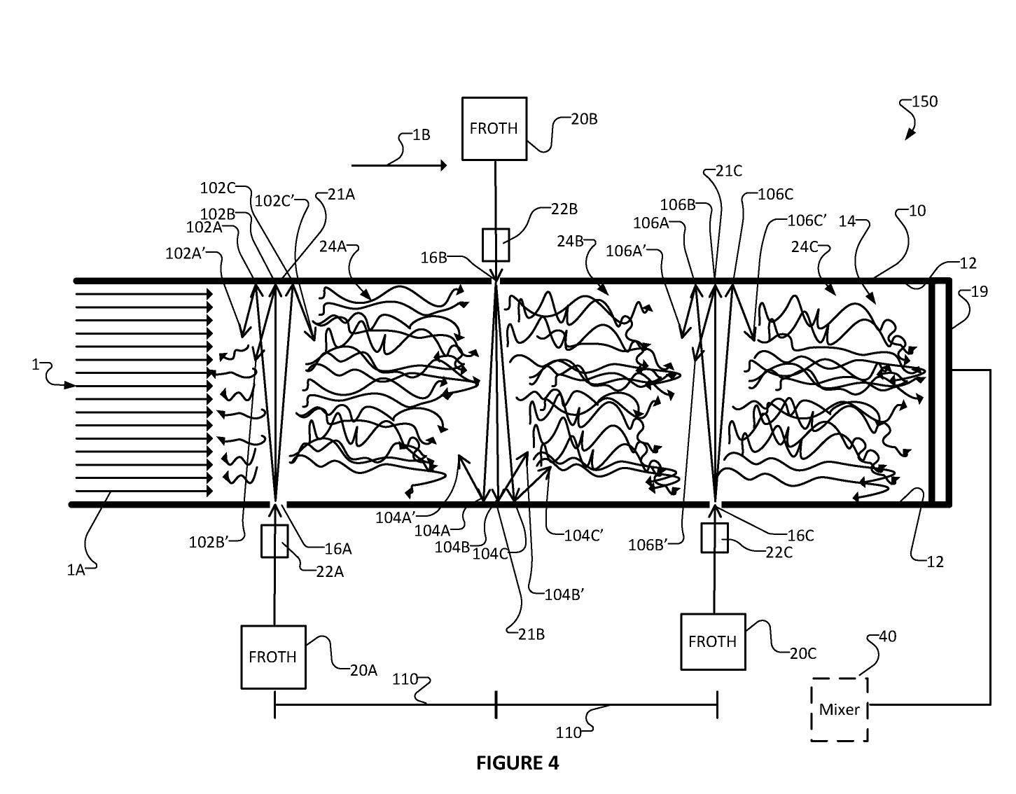

While FIGS. 2A-2D and 3A-3C illustrate the injection of froth 20 at an injection site 16 in conduit 10, in some embodiments, conduit 10 comprises a plurality of injection sites 16, each of which may be similar to injection site 16 described herein and may be used to inject fluids, such as froth 20, into bore 14. The plurality of injection sites 16 may provide unique advantages which facilitate more, and/or greater likelihood of, attachment of solids 2 to surfaces 28 of bubbles 26. FIG. 4 illustrates the use of a plurality of injection sites 16 in conduit 10 in an apparatus 150 for treating liquids containing solids according to an embodiment.

In the embodiment illustrated in FIG. 4, conduit 10 comprises a plurality (e.g. 3) of injection sites 16 (denoted as 16A, 16B, and 16C in FIG. 4) and a corresponding plurality of fluid injectors 22 (denoted as 22A, 22B and 22C in FIG. 4). In this embodiment, two of the injection sites 16 (16A and 16C) are longitudinally aligned on one longitudinal portion of conduit 10 and the remaining injection site 16C is located on the opposing side of the cross-section of conduit 10. This arrangement is not necessary. In some embodiments, injection sites 16 may all be longitudinally aligned with one another along conduit 10. In some embodiments, injection sites 16 may be distributed at different locations on conduit 10.

By injecting froth 20 through the plurality of injection sites 16, high-intensity mixing by turbulence may be created in the flow of liquid 1 and froth-liquid mixture 30 within bore 14 and through conduit 10. In the FIG. 4 embodiment, liquid 1 initially has directional flow 1A in bore 14 which has a flow direction 1B. When first (most upstream) froth 20A is injected into the first injection site 16A, directional flow 1A of liquid 1 is disrupted and froth-liquid mixture 30 is created, the flow of froth-liquid mixture 30 at locations downstream of first injection site 16A being more turbulent relative to liquid 1 upstream of first injection site 16A. Similar to the description of FIGS. 2D and 2E above, froth 20A may have velocity vectors 102 that have components in directions opposed to or orthogonal to flow direction 1B (shown as 102A, 102B, and 102C). Upon impact of froth 20A with bore-defining surface 12 at location 21A, some portions of froth 20A are redirected and such redirected froth 20A may have velocity vectors 102′ (shown as 102A′, 102B′, and 102C′) which also have components in directions opposed to or flow direction 1B.

Disruption of directional flow 1A causes a first high-intensity mixing 24A in mixture 30 and the flow of mixture 30A downstream of first injection site 16A is relatively more turbulent than directional flow 1A of liquid 1 upstream of first injection site 16A. Some portion of mixture 30 may have velocity vectors having components that are in directions opposed to or orthogonal to flow direction 1B. The high-intensity mixing 24A from turbulence in mixture 30 and the disruption of directional flow 1A, caused by injection of froth 20, promote the attachment of solids 2 to surfaces 28 at interfaces between the bubbles 26 and liquid 1.

While some elements of mixture 30 may have velocity vectors with components opposing or orthogonal to flow direction 1B downstream of first injection site 16A, in the illustrated embodiment, the average directional flow of mixture 30 continues to be in flow direction 1B. Consequently, some portion of froth-liquid mixture 30 reaches injection site 16B. Similar to the injection site 16A, froth 20B is injected at injection site 16B into bore 14 to create further turbulence and corresponding higher intensity mixing 24B of froth-liquid mixture 30, as the already turbulent flow of froth-liquid mixture 30 is further disrupted by the injection of second froth 20B. As with froth 20A injected at injection site 16A, froth 20B injected at injection site 16B may have velocity vectors (denoted as 104A, 104B, and 104C) that have components which are opposed to or orthogonal to flow direction 1B. Froth 20B injected at injection site 16B may also travel through mixture 30 and redirect off of bore-defining surface 12 at location 21B, and redirected froth 20B may have velocity vectors (denoted as 104A′, 104B′, and 104C′) that have components which are opposed to or orthogonal to flow direction 1B. The further high-intensity mixing 24B from turbulence again promotes the attachment of solids 2 to surfaces 28 at interfaces between bubbles 26 and liquid 1.

The turbulent flow of mixture 30 is still in flow direction 1B that is the same as the turbulent flow of mixture 30 prior to injection of froth 20B at injection site 16B. The same process occurs again as froth-liquid mixture 30 reaches the third injection site 16C. Injection of froth 20C into froth-liquid mixture 30 at injection site 16C causes further disruption of the turbulent flow of mixture 30 and creates a still higher intensity mixing 24C of mixture 30. Froth 20C as injected at injection site 16C may have velocity vectors (denoted as 106A, 106B, and 106C) that have components which are opposed to flow direction 1B. Froth 20C injected at injection site 16C may again travel through mixture 30 and redirect off of bore-defining surface 12 at location 21C, and redirected froth 20C may have velocity vectors (denoted as 106A′, 106B′, and 106C′) that have components which are opposed to or orthogonal to flow direction 1B. Attachment of solids 2 to surfaces 28 at interfaces between bubbles 26 and liquid 1 is again promoted by the further high-intensity mixing 24C from turbulence and the further disruption of the turbulent flow of the froth-liquid mixture 30.

In some embodiments, froth-liquid mixture 30, after high-intensity mixing from turbulence, has a velocity gradient in the bore 14 that is greater than 10 s⁻¹. In some embodiments, froth-liquid mixture 30, after high-intensity mixing from turbulence, has a velocity gradient in the bore 14 in the range between 10 s⁻¹ and 10,000 s⁻¹.

In some embodiment, the locations of injection sites 16 relative to conduit and/or to one another may be determined to ensure there is sufficient mixing and turbulence in mixture 30, and/or to provide sufficient froth 20 having charged material to create a charged environment, to have high levels of attachment of solids 2 to surfaces 28 of bubbles 26 in mixture 30. The effect of the locations of one or more injection sites 16 on achieving high levels of attachment of solids 2 may depend on a number of factors, including, without limitation, the volume of liquid 1 and mixture 30 moving through bore 14, the viscosity of liquid 1 and mixture 30, the cross-sectional area of bore 14 of conduit 10, and the pressure on liquid 1 and mixture 30 within bore 14, hydraulic characteristics of liquid 1 and mixture 30 and/or the like. To achieve a high level of attachment of solids 2 to surfaces 28, the inventor has determined that, advantageously, the injection sites 16 may be separated by a distance that is equal or less than five times the diameter of bore 14. In some embodiments, where the flow rate of liquid or mixture 30 is high, the distance between injection sites 16 in conduit 10 may be reduced.

Apparatus 150 may comprise optional mixer 40 (not shown in FIG. 4) for further mixing of mixture 30 and promotion of attachment of solids 2 to surfaces 28.

While froth 20 is injected, in the embodiments illustrated in FIGS. 2A-2D, 3A-3C, and 4, at injection sites 16 in conduit 10, injection site 16 and/or additional injection sites 16 may also be used to inject other fluids, such as coagulants, into bore 14 (e.g. into liquid 1 and/or into mixture 30). In some embodiments, both coagulants and froth 20 are injected at the same injection site 16. In some embodiments, some injection sites 16 are used for injection of froth 20 and some used for injection of coagulants.

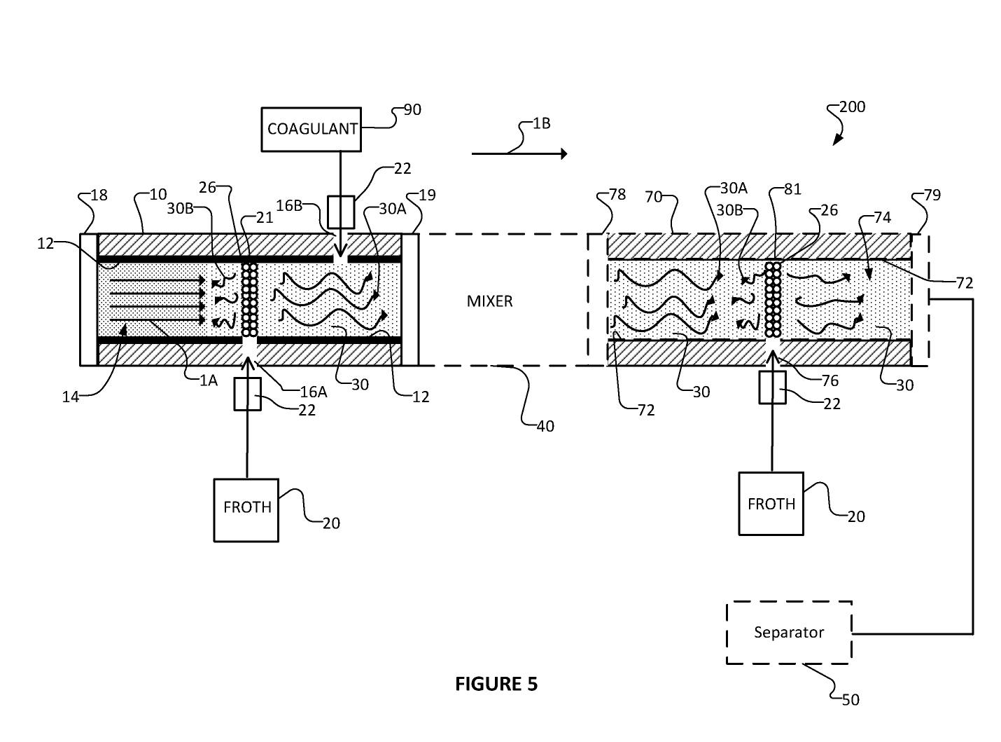

FIG. 5 shows a schematic cross-sectional side view of an apparatus 200 for treating liquid containing solids according to another embodiment. In the embodiment illustrated in FIG. 5, coagulants 90 are injected into liquid 1 at injection site 16B. Injected coagulant 90 may promote the precipitation or polymerization of dissolved solids to form precipitated solids. In some embodiments, coagulant 90 comprises one or more metal oxides, such as calcium oxide, ferric oxide, aluminum oxide, magnesium oxide, and/or the like. In some embodiments, dissolved solids comprise scaling parameters, which may include, by way of non-limiting example, silica, barium, strontium, calcium, magnesium, and/or compounds containing any of these elements. In some embodiments, the precipitated solids (i.e. the solids that come out of solution because of the addition of coagulant 90) also attach to surfaces 28 of bubbles 26. Injected coagulant 90 may also help promote the attachment of solids 2 (e.g. both the suspended and/or colloidal solids 2 originally present in liquid 1 and the newly precipitated solids which may precipitate or otherwise come out of solution because of the addition of coagulant 90) to surfaces 28 at interfaces between bubbles 26 and liquid 1. This is particularly the case where injected coagulant contributes to the charged environment in mixture 30, such as the case where coagulant 90 comprises one or more metal oxides.

Apparatus 200 for treating liquid 1 containing solids 2 as illustrated in FIG. 5 comprises an optional inline mixer 40 and optional secondary conduit 70. Optional mixer 40 may have characteristics similar to optional mixer 40 described elsewhere in this disclosure. In the illustrated embodiment of FIG. 5, optional mixer 40 is operatively connected to outlet 19 of conduit 10 and inlet 78 of secondary conduit 70. Optional secondary conduit 70 may have characteristics similar to optional secondary conduit 70 described elsewhere in this disclosure. In the illustrated embodiment of FIG. 5, optional secondary conduit 70 comprises inlet 78, outlet 79, injection site 76, and bore-defining surface 72 defining a bore 74.

In the embodiment shown in FIG. 5, liquid 1 travels within bore 14 of conduit 10 and has a directional flow 1A in a direction from inlet 18 to outlet 19. Injection of froth 20 at injection site 16A disrupts directional flow 1A of liquid 1 and creates froth-liquid mixture 30 having a turbulent flow relative to liquid 1 upstream of injection site 16A and corresponding high-intensity mixing of mixture 30. The high-intensity mixing from turbulence may be caused by portions of froth 20 having velocity vectors with components in directions opposed and orthogonal to the direction of directional flow 1A. The high-intensity mixing from turbulence and disruption of directional flow 1A promotes attachment of solids 2 to surfaces 28 at interfaces between bubbles 26 and liquid 1 in mixture 30 by increasing contact and collisions between solids 2 and between solids 2 and interfaces 28.

Mixture 30 continues to flow in flow direction 1B. As mixture 30 reaches injection site 16B, coagulant 90 is injected at injection site 16B. Coagulant 90, when injected into mixture 30, causes the precipitation or polymerization of dissolved solids to form precipitated solids. Precipitated solids mat then attach to the surfaces 28 of bubbles 26 as described above, and such attachment may be promoted by the turbulent flow of mixture 30, the high-intensity mixing of mixture 30 and/or the charged environment in mixture 30 created by the charged material in froth 20. Injected coagulants 90 may also contribute the creation of a charged environment in mixture 30, particularly where injected coagulant 90 comprises metal oxides. Accordingly, coagulants 90 may help to promote the attachment of solids 2 to surfaces 28. Precipitated solids may then be removed from mixture 30 through use of separator 50 as described elsewhere herein.

Froth-liquid mixture 30 (including solids 2 attached to surfaces 28 at interfaces between bubbles 26 and liquid 1) may be introduced into optional mixer 40. In some embodiments, conduit 10 is directly connected to mixer 40. In other embodiments, conduit 10 is operatively connected to mixer 40 by pipes, hoses, and/or or the like. Mixer 40 mixes froth-liquid mixture 30 to further promote the attachment of solids 2 to surfaces 28 by increasing the amount of collisions and contacts between solids 2 within froth-liquid mixture 30 so that they would attach to surfaces 28.

After mixing in mixer 40, froth-liquid mixture 30 (including solids 2 attached to surfaces 28) may be introduced into bore 74 of optional second conduit 70. In some embodiments, solids 2 attached to surfaces 28 are removed (e.g. using a separator similar to separator 50 described above in connection with FIG. 1) before introduction of froth-liquid mixture 30 into second conduit 70. In the FIG. 5 embodiment, inlet 72 of secondary conduit 70 is directly connected to the output of mixer 40, although this connection could be made using suitable pipes, hoses, and/or or the like. Similar to conduit 10, froth 20 is injected into froth-liquid mixture 30 within bore 74 at injection site 76 of secondary conduit 70. Injection of froth 20 into mixture 30 creates a further high-intensity mixing from turbulence in mixture 30. As with froth 20 injected at injection site 16A, froth 20 injected at injection site 76 may have velocity vectors that have components which are opposed to or orthogonal to flow direction 1B. High-intensity mixing from turbulence and disruption turbulent flow of mixture 30 cause increased contact and collisions between solids 2 within froth-liquid mixture 30 and between solids 2 and surfaces 28 and promote the attachment of solids 2 to surfaces 28.

In some embodiments, froth 20 comprises a charged material and creates a charged environment in froth-liquid mixture 30. The creation of charged environment promotes the disruption of double electric layer 60 surrounding solids 2 and further promotes the attachment of solids 2 to surfaces 28.

As will be apparent to those skilled in the art in the light of the foregoing disclosure, many alterations and modifications are possible in the practice of this invention without departing from the spirit or scope thereof. For example:
A plurality of conduits may be used in any of the apparatus described herein to promote attachment of solids 2 to surfaces 28.
Solids 2 attached to surfaces 28 may be removed after each treatment within a conduit in a sequential treatment process.
The density of injection sites may be dependent on the flow velocity of liquid 1 and/or froth-liquid mixture 30.
In some embodiments, injection of froth 20 into the conduit may be manually controlled.
In some embodiments, injection of froth 20 into the conduit is controlled by a controller (not shown), the controller receiving feedback corresponding to detected flow conditions within bore of conduits by sensors (not shown) located therein. By way of non-limiting example, such sensors may comprise flow rate sensors, temperature sensors, pressure sensors, temperature sensors, concentration sensors and/or the like. Controller may comprise any suitable controller, such as, for example, a suitably configured computer, microprocessor, microcontroller, field-programmable gate array (FPGA), other type of programmable logic device, pluralities of the foregoing, combinations of the foregoing, and/or the like. Controller may have access to software which may be stored in computer-readable memory accessible to controller and/or in computer-readable memory that is integral to controller. Controller may be configured to read and execute such software instructions and, when executed by controller, such software may cause controller to implement some of the functionalities described herein.
In some embodiments, mixer 40 comprises a tank mixer.
Coagulants 90 may be added before or after injection of froth 20 into liquid 1 and/or mixture 30.
Hydraulic characteristics of liquid 1 may be modified.
In some embodiments, the diameters of the bore in conduits may be between 3 mm-6000 mm.

While a number of exemplary aspects and embodiments have been discussed above, those of skill in the art will recognize certain modifications, permutations, additions and sub-combinations thereof.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

While a number of exemplary aspects and embodiments have been discussed above, those of skill in the art will recognize certain modifications, permutations, additions and sub-combinations thereof.

It is therefore intended that the scope of the invention should not be limited by the embodiments set forth in the examples set out above, but should be given the broadest interpretation consistent with the description as a whole.

1. A method for treating a liquid containing solids, the method comprising:
introducing the liquid into a conduit having a bore-defining surface which defines a bore, and an injection site for fluid injection into the bore, the liquid having a directional flow in a flow direction in the bore and the liquid filling the bore at locations upstream of the injection site; and
injecting a froth into the liquid at the injection site, injecting the froth comprising:
disrupting the directional flow of the liquid; and
creating a froth-liquid mixture at locations downstream from the injection site, the froth-liquid mixture exhibiting turbulent flow in the flow direction and corresponding high-intensity mixing of the froth-liquid mixture.

2. A method according to claim 1 comprising attaching the solids to surfaces at interfaces between the bubbles and the liquid, the attachment of the solids promoted by the disruption of the directional flow of the liquid, the turbulent flow of the froth-liquid mixture and the corresponding high-intensity mixing.

3. A method according to claim 1 wherein injecting the froth comprises injecting the froth to move through the liquid and to impact the bore-defining surface at a location spaced apart and generally across the bore from the injection site.

4. A method according to claim 1 wherein disrupting the directional flow comprises causing some portions of the liquid to have velocity vectors with components oriented in a direction opposed to the flow direction and wherein disrupting the directional flow is caused by causing some portions of the froth to have velocity vectors with components oriented in the direction opposed to the flow direction.

5.-7. (canceled)

8. A method according to claim 1 wherein the froth comprises a charged material and the method comprises creating a charged environment in the liquid to promote the attachment of the solids and wherein the solids are surrounded by a double electric layer and the method comprises disrupting the double electric layer by the charged environment and by the high-intensity mixing, thereby permitting attractive forces to become dominant so that solids attach to the surfaces at interfaces between the bubbles and the liquid.

9.-10. (canceled)

11. A method according to claim 8 or any other claim herein wherein disrupting the double electric layer causes Van der Waals forces to promote the attachment of the solids.

12. A method according to claim 1 wherein the froth comprises surfactant, a base liquid, and gas.

13. A method according to claim 1 comprising injecting a coagulant into at least one of the liquid and the froth-liquid mixture to promote the precipitation or polymerization of dissolved solids into precipitated solids and attaching the precipitated solids to the surfaces at the interfaces between the bubbles and the liquid, the attachment of the precipitated solids promoted by the disruption of the directional flow of the liquid and the high-intensity mixing of the froth-liquid mixture.

14. (canceled)

15. A method according to claim 1 comprising mixing the froth-liquid mixture in a mixer to cause further turbulence in, and higher-intensity mixing of, the liquid-froth mixture and to further promote the attachment of the solids.

16. A method according to claim 1 wherein the conduit comprises a plurality of injection sites and the method comprises injecting the froth into the bore at the plurality of injection sites wherein the injection sites are spaced apart at a distance that is less than or equal to five times a diameter of the bore.

17. (canceled)

18. A method according to claim 1 comprising:
introducing the froth-liquid mixture into a second conduit having a second bore-defining surface which defines a second bore; and
injecting additional froth into the froth-liquid mixture in the second bore at one or more second conduit injection sites.

19. A method according to claim 1 wherein injecting the froth comprises determining an injection pressure for froth injection wherein determining the injection pressure is based at least in part on an average velocity of the directional flow of the liquid.

20.-23. (canceled)

24. A method according to claim 1 comprising removing the bubbles and the solids attached to the surfaces at interfaces between the bubbles and the liquid.

25. An apparatus for treating a liquid containing solids, the apparatus comprising:
a conduit having a bore-defining surface which defines a bore and an injection site for fluid injection into the bore, the liquid having a directional flow in a flow direction in the bore and filling the bore at locations upstream of the injection site; and
a froth injected into the liquid at the injection site, the injected froth disrupting the directional flow of the liquid and creating a froth-liquid mixture comprising gaseous bubbles in the liquid at locations downstream from the injection site, the froth liquid mixture exhibiting a turbulent flow in the flow direction and corresponding high-intensity mixing of the froth-liquid mixture.

26. An apparatus according to claim 25 wherein the solids attach to surfaces at interfaces between the bubbles and the liquid, the attachment of the solids promoted by the turbulence and the disruption.

27. An apparatus according to claim 25 wherein the injected froth is injected at a pressure and direction which causes the injected froth to move through the liquid and impact the bore-defining surface at a location spaced apart from and generally across the bore from the injection site.

28. An apparatus according to claim 25 wherein the disruption of the directional flow comprises some portions of the liquid having velocity vectors with components oriented in a direction opposed to the flow direction and wherein disruption of the directional flow comprises some portions of the froth having velocity vectors with components oriented in the direction opposed to the flow direction.

29.-31. (canceled)

32. An apparatus according to claim 25 wherein the froth comprises a charged material for creating a charged environment in the liquid to promote the attachment of the solids and wherein the solids are surrounded by a double electric layer which is disrupted by the charged environment and by the high-intensity mixing, thereby permitting attractive forces to become dominant so that solids attach to the surfaces at interfaces between the bubbles and the liquid.

33.-34. (canceled)

35. An apparatus according to claim 32 wherein the disruption of the double electric layer causes Van der Waals forces to promote the attachment of solids.

36. An apparatus according to claim 25 wherein the froth comprises surfactant, a base liquid, and gas.

37. An apparatus according to claim 25 comprising a coagulant injected into at least one of the liquid and the froth-liquid mixture, the coagulant promoting the precipitation or polymerization of dissolved solids into precipitated solids, the precipitated solids attaching to the surfaces of the interfaces between the bubbles and the liquid, the attachment of the precipitated solids promoted by the disruption of the directional flow of the liquid and the high-intensity mixing of the froth-liquid mixture.

38. (canceled)

39. An apparatus according to claim 25 comprising a mixer located downstream of the injection site for mixing the froth-liquid mixture to cause further turbulence in, and higher-intensity mixing of, the froth-liquid mixture and to further promote the attachment of the solids.

40. A method according to claim 25 wherein the conduit comprises a plurality of injection sites for injection of the froth and wherein the injection sites are spaced apart at a distance that is at or less than five times the diameter of the bore.

41. (canceled)

42. An apparatus according to claim 25 comprising a second conduit having a second bore-defining surface defining a second bore, the second conduit connected to receive the froth-liquid mixture and comprising one or more second injection sites for injection of additional froth into the froth-liquid mixture in the second bore wherein the second conduit is connected to receive the froth-liquid mixture from a mixer operatively connected between the conduit and the second conduit, the mixer mixing the froth-liquid mixture to cause further turbulence in, and higher-intensity mixing of, the froth-liquid mixture and to further promote the attachment of the solids.

43. (canceled)

44. An apparatus according to claim 25 comprising an injector operatively connected at the injection site for injecting the froth at an injection pressure, the injection pressure based on a velocity of the directional flow of the liquid.

45.-48. (canceled)

49. An apparatus according to claim 25 comprising a separator for removing the bubbles and the solids attached to the surfaces at interfaces between the bubbles and the liquid.

50.-51. (canceled)
